(19) United States
(12) Patent Application Publication
(10) Pub. No.: US 2008/0291043 A1
(43) Pub. Date: Nov. 27, 2008

(54) SYSTEM AND METHOD FOR DEVICE ACTIVATION

(76) Inventor: Mark Duron, East Patchogue, NY (US)

Correspondence Address: FAY KAPLUN & MARCIN, LLP, 150 BROADWAY, SUITE 702, NEW YORK, NY, 10038, US

(21) Appl. No.: 11/752,595

(22) Filed: May 23, 2007

(51) Int. Cl. G08B 21/00

(52) U.S. Cl. 340/686.6

(57) ABSTRACT

Described is a device and a method of operating the device. The device comprises a function module and a triggering arrangement activating a function of the function module in a response to a triggering condition. The triggering arrangement generates an interrogation signal, the response including at least one of (i) modifying a frequency of the interrogation signal, (ii) modifying a duration of the interrogation signal and (iii) modifying non-monotonic temporal distributions of interrogation events.

### FIELD OF INVENTION

The present application generally relates to systems and methods for a device activation.

### BACKGROUND INFORMATION

As electronic devices become increasingly complex, more power is required to operate the devices. In addition to increasing power supply capacities, various methods have been introduced for minimizing power consumption. Power management is of particular concern in mobile devices (e.g., cell phones, image or laser-based scanners, radio-frequency identification (“RFID”) readers, radio transceivers, etc.), which rely on a finite energy source, generally in the form of a battery. The mobile devices often include a radio-frequency (“RF”) arrangement which transmits an interrogation signal to detect neighboring devices or objects (e.g., RFID tags). Frequent use of the RF arrangement creates a large power demand. Problems associated with conventional operation of an RF-based mobile device will now be described with reference to FIG. 1.

FIG. 1 shows a conventional time diagram illustrating two RF interrogation signals 120 and 130. The signals 120, 130 indicate the use of RF in a mobile device responding to an input signal 100, which corresponds to an object being brought into or out of an interrogation range. As seen in FIG. 1, the input signal 100 may be comprised of three input pulses 10, 20 and 30 which occur when the object is brought within the detection range. The signal 120 represents a conventional interrogation signal which is held continuously throughout a duration of operation. This produces a single pulse 122 which begins immediately from a moment of device activation (e.g., when the mobile device is powered-on) and ends when the mobile device is deactivated. Because the signal 120 is always asserted, any input signal (e.g., the pulses 10-30) is likely to be captured. However, the conventional method illustrated by the signal 120 potentially consumes a large amount of energy. If the mobile device is battery-operated, this can quickly deplete any energy stored within the battery. Even if the mobile device has an unlimited energy supply, operating the mobile device in such a manner is a spectrally and thermally inefficient method of providing power, which results in higher operating costs.

The signal 130 represents a conventional method for decreasing power consumption by operating on a duty cycle. The signal 130 operates on a fixed frequency and with a fixed pulse length. As shown in FIG. 1, the signal 130 comprises a plurality of pulses 132, 134 and 136, each having the same duration 33. The pulses 132, 134 and 136 are produced in intervals of duration 35. An advantage of not operating the signal 130 continuously is that power consumption is decreased. However, the signal 130 may not always capture the input signal 100. As seen in FIG. 1, the pulse 132 ends before the input pulse 10 begins and the pulse 134 begins after the input pulse 10 ends. Therefore, the signal 130 is unable to capture the pulse 10. An overlap 37 between the input pulse 20 and the pulse 134 may be substantial, allowing sufficient time for the input pulse 20 to be captured. However, in some situations the time overlap is too short, as illustrated by an overlap 39 between the input pulse 30 and the pulse 136. In such situations, the mobile device may detect the presence of the object, but is unable to capture the input pulse.

### SUMMARY OF THE INVENTION

The present invention relates to a device including a function module and a triggering arrangement which activates a function of the function module in a response to a triggering condition. The triggering arrangement generates an interrogation signal and the response includes at least one of modifying a frequency of the interrogation signal, modifying a duration of the interrogation signal and modifying non-monotonic temporal distributions of interrogation events.

The present invention also relates to a method including the steps of detecting a triggering condition using an interrogation signal of a device and in response to the detection, modifying the interrogation signal, wherein the modification includes at least one of modifying a frequency of the interrogation signal, modifying a duration of the interrogation signal and modifying non-monotonic temporal distributions of interrogation events.

### BRIEF DESCRIPTION OF THE DRAWINGS

FIG. 1 shows a conventional time diagram of two interrogation signals.

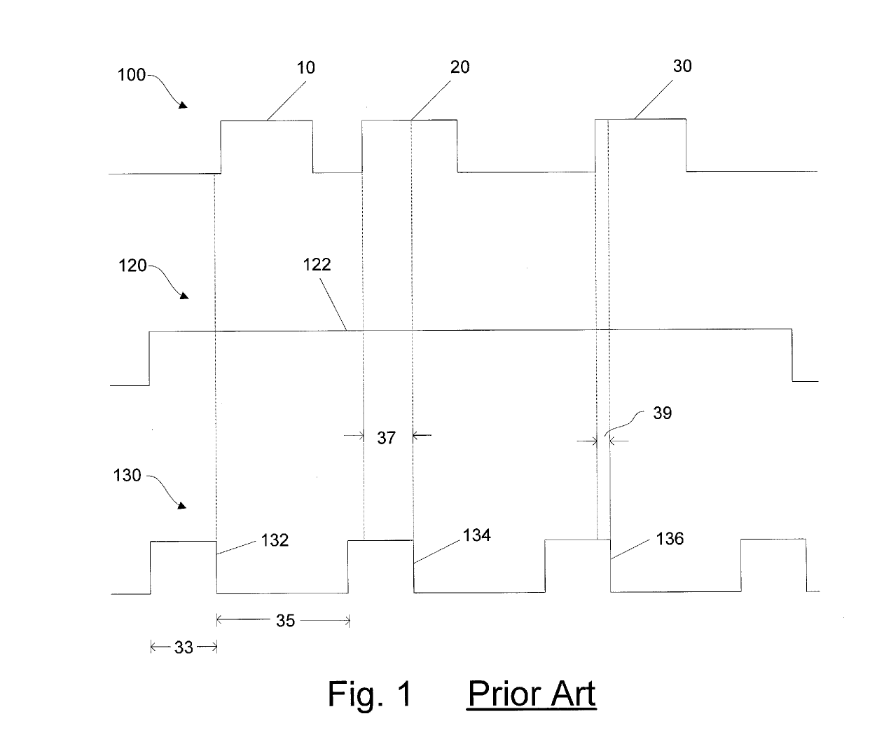

FIG. 2 shows a block diagram of a mobile device according to an exemplary embodiment of the present invention.

FIG. 3 shows a perspective view of the mobile device of FIG. 2.

FIG. 4 shows a time diagram of a first interrogation signal according to an exemplary embodiment of the present invention.

FIG. 5 shows a first method according to an exemplary embodiment of the present invention.

FIG. 6 shows a time diagram of a second interrogation signal according to an exemplary embodiment of the present invention.

FIG. 7 shows a second method according to an exemplary embodiment of the present invention.

FIG. 8 shows a time diagram of a third interrogation signal according to an exemplary embodiment of the present invention.

FIG. 9 shows a third method according to an exemplary embodiment of the present invention.

### DETAILED DESCRIPTION

The present invention may be further understood with reference to the following description and the appended drawings, wherein like elements are provided with the same reference numerals. The present invention relates to systems and methods for activating (e.g., triggering a function of) a device. Various embodiments of the present invention will be described with reference to a wearable radio-frequency identification (“RFID”) reader. However, those skilled in the art will understand that the present invention may be implemented with any electronic device which utilizes an interrogation signal for triggering purposes. For example, the electronic device may be a mobile or portable device such as a laptop, a cell phone, a personal digital assistant, a global positioning system handheld, etc. The electronic device may also be a stationary device such as a Blue-tooth enabled desktop computer, an image or laser-based scanning station, an RFID interrogation station, a network router, an network interface card, etc.

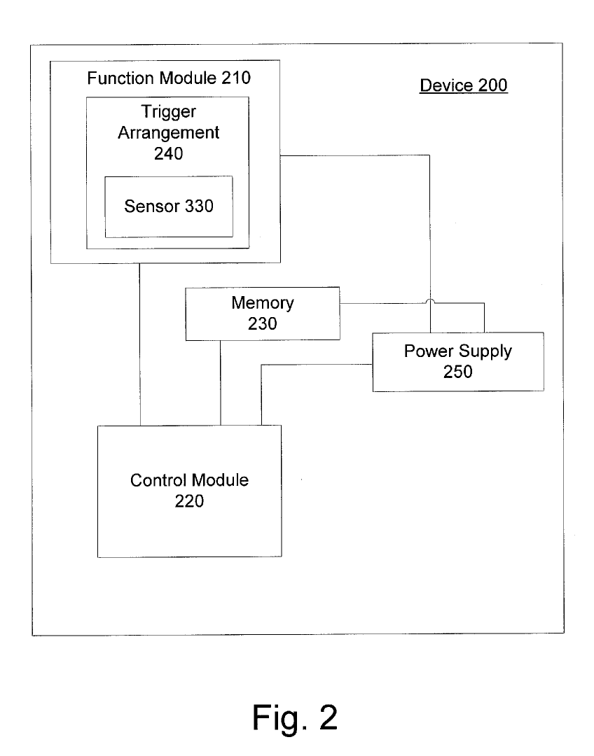

FIG. 2 shows a block diagram of an exemplary embodiment of a mobile device 200 according to the present invention. The device 200 may be used to implement any of the methods for device activation that will be described below. As shown in FIG. 2, the device 200 may include a function module 210 communicatively coupled to a control module 220. The function module 210 may include one or more electrical and/or mechanical components for executing a function of the device 200. For example, if the device 200 is an RFID reader, the function module 210 may include an RF transmitting and receiving arrangement for reading RF tags. The function module 210 may also include software components for controlling operation of the electrical/hardware components.

The function module 210 may further include a trigger arrangement 240 which detects a triggering condition upon which the function module 210 is activated. If the device 200 is the RFID reader, the trigger arrangement 240 may include a sensor 330 for detecting an RF input signal. This input signal may come from a variety of sources, including another RF-enabled device (e.g., another mobile unit or a base unit) and an object with an RFID tag attached. The trigger arrangement 240 may also produce an RF interrogation signal which enables the sensor 330. The interrogation signal may function as a control signal for the sensor 330. In situations where the sensor 330 is anticipating the arrival of the input signal (e.g., the other device transmits a request or probe signal, or the RFID tag is an active tag) the interrogation signal may enable power to be supplied to the sensor 330, enabling signal detection. Other situations may require the device 200 to initiate communication with the device/tag (e.g., the sensor 330 transmits a probe signal to the other device or to a passive tag). In these latter situations, the interrogation signal may enable the sensor 330 to produce a probe signal whenever the interrogation signal is asserted.

The function module 210 may include any number of functionalities. One functionality may include performing an operation upon data received via the sensor 330. For example, tag data may include an identifier field along with other data fields. The function module 210 may, in response to the input signal, read the tag data, update a database in a memory 230 or a remote device (e.g., a server) by adding a corresponding record to the database or searching the database for a record corresponding to the identifier, and modify the record using information derived from the tag data and/or user input. In other embodiments, the function module 210 may include other functions activated by the trigger arrangement 20, including showing information on a display (e.g., a liquid crystal display) of the device 200.

The control module 220 regulates the operation of the device 200 by facilitating communications between the various components of the device 200. The control module 220 may, for example, include a processor such as a microprocessor, an embedded controller, an application-specific integrated circuit, a programmable logic array, etc. The processor may perform data processing, execute instructions and direct a flow of data between devices coupled to the control module 220 (e.g., a memory 230 and the function module 210). The control module 220 may trigger a function of the device 200 based on a response of the trigger arrangement 240 to the input signal, which corresponds to a triggering condition (e.g., bringing the device 200 within a detection range of the object or tag). For example, the control module 220 may extract the information from the tag data and pass this information to the function module 210 for further processing.

The memory 230 may be any storage medium capable of being read from and/or written to. The memory 230 may include any combination of volatile and/or nonvolatile memory (e.g., RAM, ROM, EPROM, Flash, etc.) The memory 230 may also include one or more storage disks such as a hard drive. In one embodiment, the memory 230 is a temporary memory in which data may be temporarily stored until it is transferred to a permanent storage location (e.g., uploaded to a personal computer or server). In another embodiment, the memory 230 may be a permanent memory comprising a database.

The power supply 250 provides power to each component coupled thereto and may include a built-in power source (e.g., a battery) that may be rechargeable and/or replaceable. In addition or in alternative to the built-in source, the power supply 150 may include an arrangement for receiving an external power source (e.g., a AC-to-DC converter). As shown in FIG. 2, the power supply 250 may be coupled to each of the function module 210, the control module 220, and the memory 230. Thus, the power supply 250 may provide power to each of these components.

Various embodiments of the present invention will now be described with reference to a wearable RFID reader. Wearable readers may be used in situations where it is desirable to operate a reader without requiring a user to hold it. This allows the user to use his hand for other purposes such as picking up an object, typing on a keyboard, writing, etc. However, the present invention may also be implemented in other types of RF-enabled devices.

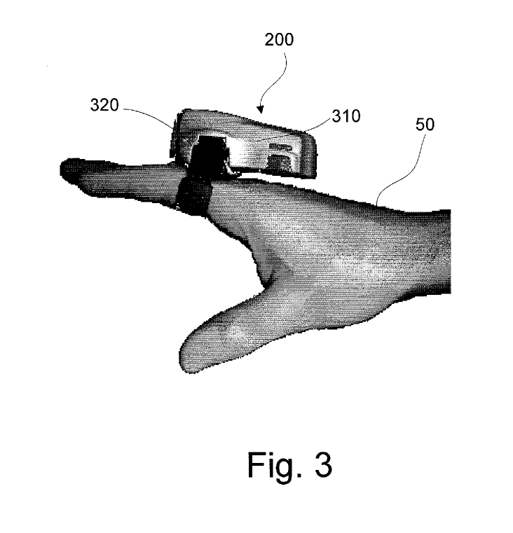

FIG. 3 shows a perspective view of the device 200, which may be worn over one or more fingers of a hand 50 and may include a device housing 310 wearably coupled to the one or more fingers via a strap 320. In other embodiments, the device 200 may be attached to other parts of the user's body (e.g., a forearm, a wrist, a leg, a neck, a forehead, an ankle, etc.). The strap 320 may be formed of any suitably flexible material such as plastic, rubber or leather. Various attachment techniques may be used to adjust a fit of the strap 320. For example, a length of the strap 320 may be adjusted if the strap 320 is implemented with Velcro®, as a stretchable band, a belt, etc. Other attachment techniques may also be possible and will be apparent to one skilled in the art.

The sensor 330 may be located entirely within the housing 310. For example, the sensor 330 may include an internal antenna which transmits and receives RF signals. In other embodiments, the sensor 330 may be partially or entirely disposed on an exterior of the housing 310. For example, the sensor may include an external antenna (not shown) which extends from a top or a side of the housing 310. The external antenna may be a stub or retractable.

The triggering condition may be user-produced. For example, in a warehouse environment, the user may pick up and bring the object within the detection range, thus, causing a triggering condition if the interrogation signal is asserted. In some instances, the triggering condition may not be user-produced (e.g., an external condition) or the triggering condition may be produced without triggering being a conscious object of the user. For example, the user may, in the process of moving about the warehouse, encounter random objects which cause triggering.

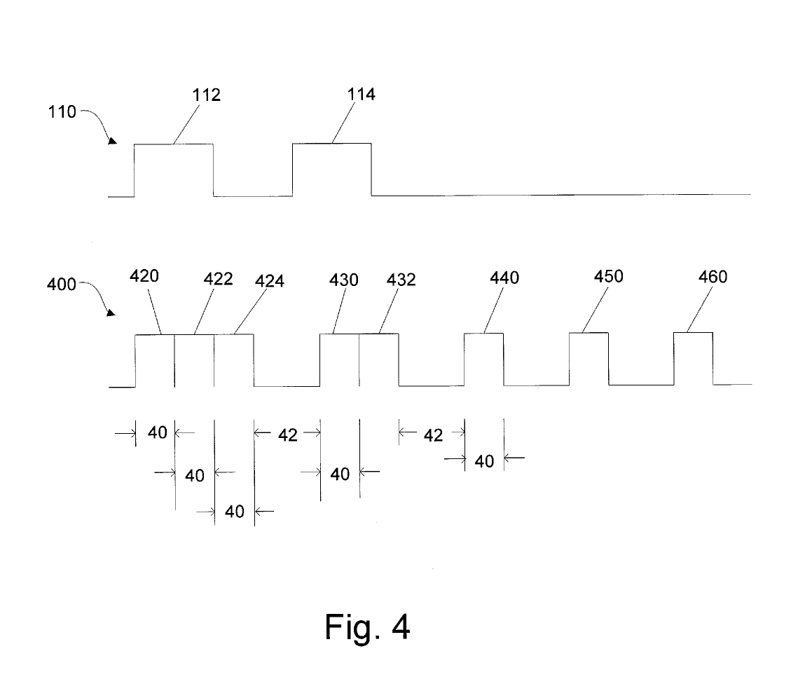

FIG. 4 shows a time diagram of an exemplary embodiment of an interrogation signal 400 according to the present invention. The interrogation signal 400 may be produced by the control module 220 or by a circuit within the trigger arrangement 240. As shown in FIG. 4, the signal 400 may be responsive to an input signal 110, which represents the triggering condition. That is, when the object is brought within the detection range (indicated by one or more pulses 112 and 114) the signal 400 may adapt itself to the triggering condition.

The signal 400 may be comprised of a series of pulses 420, 422, 424, 430, 432, 440, 450 and 460. Each of the pulses may be substantially similar in duration and may be produced by a timing circuit of the control module 220 or the trigger arrangement 240. In the absence of any input signal, the signal 400 may operate on a fixed duty cycle. For example, the signal 400 may be comprised of a series of pulses of duration 40 (e.g., 25 milliseconds) which are repeated in intervals of duration 42 (e.g., 300 milliseconds). Thus, an exemplary duty cycle might be 25/300 or 8.3 percent. However, when an input signal is detected, the signal 400 may immediately repeat a pulse, effectively extending a duration of a current pulse by adding an additional pulse. This is illustrated in FIG. 4, where the pulses 422 and 424 are produced in response to a continued capturing of the input pulse 112. A similar scenario occurs when the pulse 432 is produced after the input pulse 114 is captured.

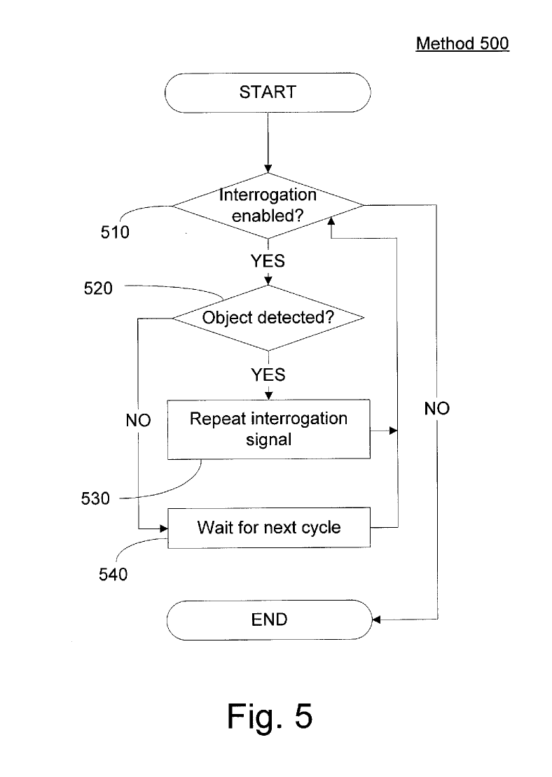

The method illustrated by the signal 400 is summarized in FIG. 5, which shows an exemplary embodiment of a method 500 according to the present invention. The method 500 and each of the methods disclosed herein may be implemented in any combination of hardware and/or software. In an exemplary embodiment, the methods described may be implemented on the control module 220. However, the methods may also be implemented elsewhere in alternative embodiments. In step 510, the device 200 determines whether interrogation is enabled. This may be determined based on any number of conditions, including whether the device 200 is powered-on, whether the device 200 is expecting input and whether the device 200 is currently busy with another operation.

In step 520, once the interrogation is enabled, the device 200 determines whether the object (e.g., the other device or the RFID tag) is detected. If the object is not detected, the device 200 waits for a next cycle (step 540) and returns to step 510. Referring back to FIG. 4, this is illustrated by each interval of duration 42 in which the signal 400 is not being asserted.

In step 530, the object has been detected and a duration of a current pulse is extended by repeating the interrogation signal at least once. This may be accomplished by letting the current pulse terminate and then instantaneously asserting a new pulse of duration 40. Alternatively, the duration of the current pulse may be extended without allowing the current pulse to terminate early. The method 500 then returns to step 510.

Optionally, the extending of the current pulse may be contingent upon one or more conditions in addition to the presence of the object. For example, in one embodiment, the condition may be a classification of the object. For example, objects may be categorized according to different classes (e.g., class A, class B, class C, etc.) by the user. Certain classes may warrant more attention than others. The current pulse may also be extended by varying amounts depending on the object's class. Extending may also be denied depending on class. Thus, the extending of the pulse may be class-sensitive. Class detection may occur when the object transmits an identification data to the device 200. The identification data may comprise part of the input signal or a separate signal.

In another embodiment, the condition may be based upon physical locations, which may be divided into zones of interest. For example, a location may be divided into one or more zones by marking boundaries (e.g., corners) of each zone using an RFID tag (e.g., a beacon tag) or other device capable of wirelessly transmitting data that identifies the zone. Thus, the extending of the current pulse may depend on whether the object is detected in a particular zone. In yet another embodiment, the extending of the current pulse may be conditioned on a plurality of conditions. For example, the extending may be both class and zone-sensitive.

The extending of the current pulse may also be conditioned on whether other devices are currently interrogating. For example, if the device 200 is interrogating in the same zone as a second device and detects the object, the device 200 may forego extending the current pulse in order to avoid signal collisions. This may occur, for example, if both devices are operating on the same or a similar frequency.

The detection of the object continues until interrogation is disabled. As long as the object is detected, the current pulse is extended by adding an additional pulse. Once the object is no longer detected (e.g., the device 200 is moved away from the object), the current pulse is allowed to terminate and the signal 400 is not reasserted until the next cycle.

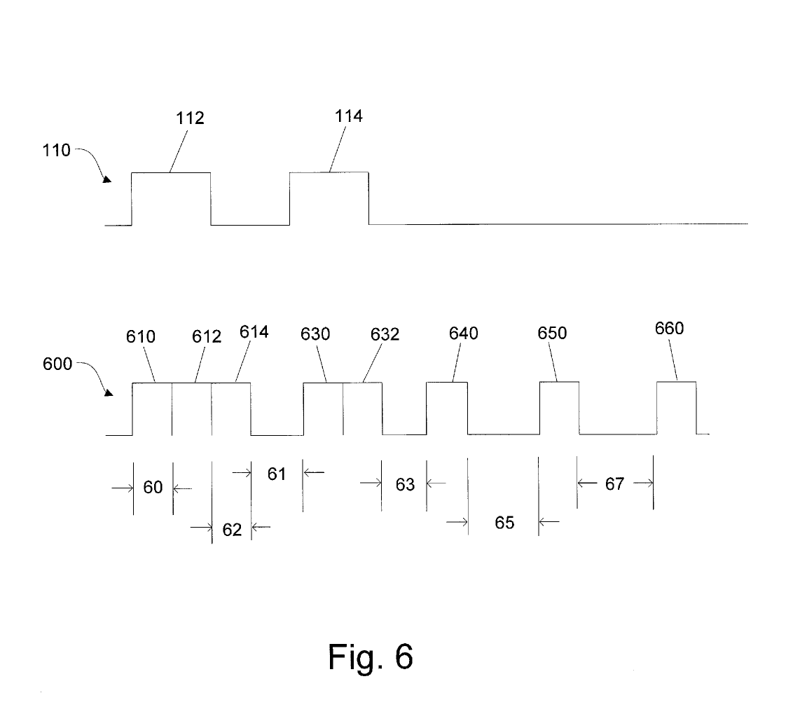

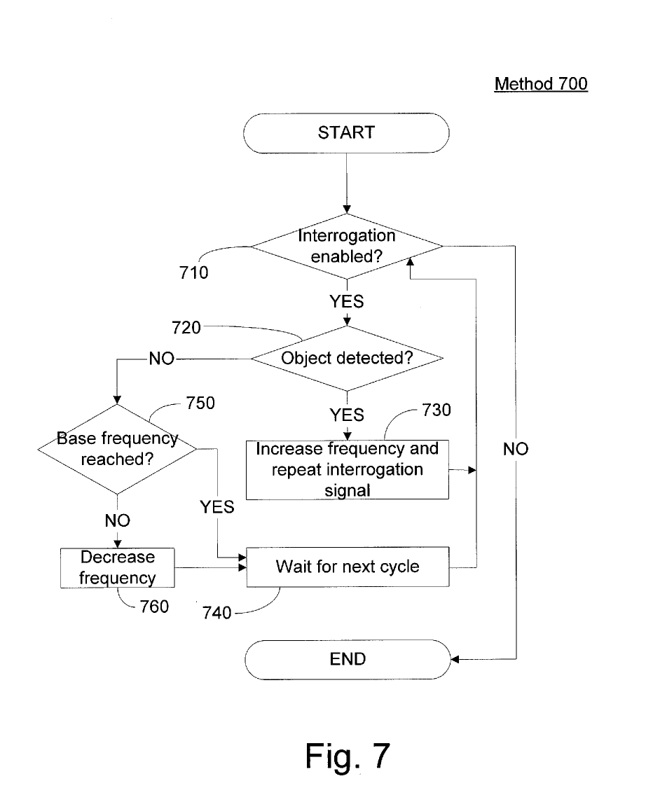

FIG. 6 shows a time diagram of an exemplary embodiment of an interrogation signal 600 according to the present invention. The signal 600 may comprise a series of pulses 610, 612, 614, 630, 632, 640, 650 and 660, and is shown responding to the signal 110 previously described with reference to FIG. 4. The signal 600 may behave in a manner similar to that of the signal 400 in that if the object is detected, a frequency of the signal 600 is increased. This is illustrated in FIG. 7, which shows an exemplary embodiment of a method 700 according to the present invention. In step 710, the device 200 determines whether interrogation is enabled. This determination may be based on conditions substantially similar to those previously discussed with reference to step 510 of the method 500.

In step 720, once the interrogation is enabled, the device 200 determines whether the object is detected. If the object is detected, the interrogation signal is repeated by extending the current pulse (step 730). This is illustrated by the pulses 612, 614 and 632. In addition to repeating the signal 600, a current frequency of the signal 600 is increased, resulting in shorter intervals between repetitions of each pulse. The increase in frequency may be based on a predetermined formula (e.g., a linear or exponential growth formula). Thus, continued detection of the object may result in progressively shorter cycles.

Exponential frequency increases may correspond to a “fast attack, slow decay” mode in which interrogation frequency is rapidly increased upon detection of the object and maintained at a high frequency for a period of time even if the object is no longer detected. The fast attack mode may be initiated based on one of the conditions discussed above (e.g., object class and/or zone) or, alternatively, the device 200 may be configured to always operate in the fast attack mode. For example, in one embodiment, the fast attack mode may correspond to one or more zones in which aggressive pinging is desired. Thus, if the object is detected within an aggressive zone, the current frequency is rapidly increased.

If the object continues to be detected for an extended period of time, the current frequency may asymptotically approach an upper limit (e.g., a point where the signal 600 resembles a continuous signal). Initially, the signal 600 may begin with a base frequency, which may be any predetermined operating frequency upon which the signal 600 operates. For example, the base frequency may be experimentally determined based on an average time it takes for the object to no longer be detectable once the user begins to move the device 200 away. After the current frequency is increased and the signal 600 has been repeated, the method 700 returns to step 710.

In step 750, the object is not detected and the device 200 determines whether the base frequency has been reached. If the base frequency is reached, the device 200 waits for the next cycle before asserting the signal 600 (step 740). However, if the base frequency has not been reached, the current frequency is decreased (e.g., linearly or exponentially), which results in an increase in the time between cycles (step 760). For example, the fast attack mode may utilize linear or inversely exponential decreases in frequency in order to cause gradual changes in the current frequency. In any case, the device 200 waits for the next cycle (step 740) before returning to step 710.

Referring back to FIG. 6, the decrease in the current frequency is shown when the signal 600 is reasserted during the pulse 614, after the current frequency has been increased during the pulses 610 and 612. During the pulse 614, the object is not detected and the current frequency is decreased as shown by a duration 61. Because the frequency was previously increased during the pulses 610 and 612, the current frequency represented by the duration 61 may still be larger than the base frequency. The current frequency is increased again during the pulse 630, which coincides with the input pulse 114. After the pulse 630 terminates, the object is not detected during a latter portion of the pulse 632 and also during an entire duration of each of the pulses 640, 650 and 660. During each of these pulses 632-660, the current frequency is decreased, as shown by progressively increasing durations 63, 65 and 67.

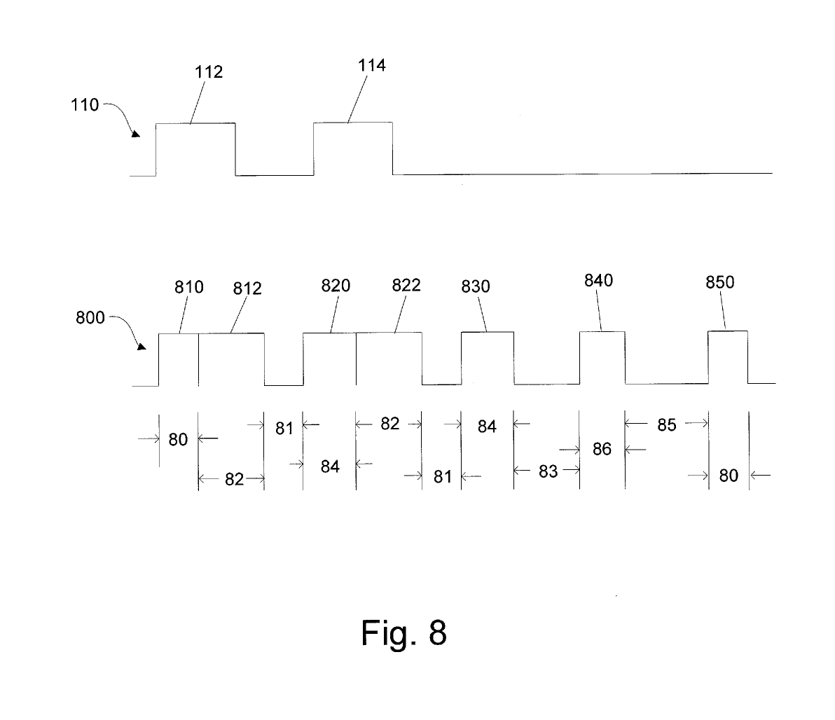

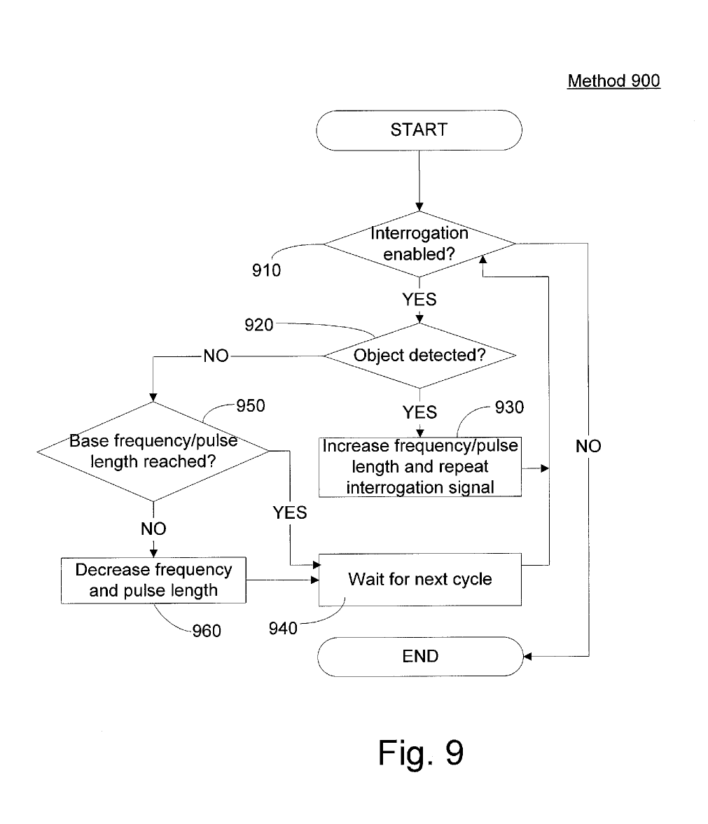

FIG. 8 shows an exemplary embodiment of an interrogation signal 800 according to the present invention. The signal 800 may comprise a series of pulses 810, 812, 820, 822, 830, 840 and 850. As explained below with reference to FIG. 9, the signal 800 may behave in a similar manner to the signal 600 in that the current frequency is increased if the object is detected or decreased if the object is not detected. However, the signal 800 may also respond to the input signal 110 by modifying a duration of each pulse depending on whether or not the object is detected.

FIG. 9 shows an exemplary embodiment of a method 900 according to the present invention. In step 910, the device 200 determines whether interrogation is enabled. If interrogation has been enabled, the device 200 then determines whether the object is detected (step 920).

In step 930, the object is detected and a current frequency of the signal 800 is increased. As with the signal 600, the signal 800 may initially start at a base frequency. In addition, a duration of the pulses (i.e., a current pulse length) is increased before repeating the signal 800. Thus, the signal 800 may also have a base pulse length. After the current frequency and pulse length have been increased, the device 200 waits for the next cycle before returning to step 910 (step 940).

In step 950, the object is not detected and it is determined whether the base frequency and the base pulse length have been reached. If the based frequency/pulse length are reached, the method 900 proceeds to step 940. However, if the base frequency/pulse length have not been reached, both the current frequency and the current pulse length are decreased before returning to step 940 (step 960).

Referring back to FIG. 8, the modification of the pulse length and frequency is illustrated by the pulses 810-850. During the pulse 810, the object is detected and the pulse length is increased as shown by a duration 82 of the pulse 812. During this time, a current frequency of the signal 800 is also increased. During a latter portion of the pulse 812, the object is not detected and the pulse length and frequency are decreased as respectively shown by durations 84 and 81. This decrease in pulse length and frequency also occurs during a beginning portion of the pulse 820. During a latter portion of the pulse 820 and also during a beginning portion of the pulse 822, the pulse length and frequency are increased when the object is detected. The pulse length and frequency are then decreased again during a latter portion of the pulse 822 and during the pulses 830-850, which have successively shorter lengths 84, 86 and 80, and which are separated by successively increasing durations 81, 83 and 85.

Based on the exemplary embodiments described above, it can be seen that a response of the interrogation signal to the detection of the object generally results in a non-monotonic temporal distribution of interrogation events triggered by the interrogation signal. That is, the frequency and pulse length of the interrogation signal are neither constantly increasing nor constantly decreasing as a function of time. As the frequency and/or pulse length is changed in response to further detection or non-detection of the object, the non-monotonic distribution is also modified accordingly.

In other embodiments of the method 900, the frequency and the pulse length may not be concurrently increased and/or decreased. In one embodiment, the frequency may be increased and, if after a predetermined time period the object remains detectable, the pulse length may also be increased. In another embodiment, the pulse length may be increased before the frequency. Similarly, the decreasing of the frequency and pulse length may occur in a non-concurrent manner. In still further embodiments, the increasing and decreasing of the frequency and pulse length may be controlled by additional factors other than the input signal 110. For example, another factor may be whether multiple objects are simultaneously detected. Thus, the device 200 may include a matrix or table of conditions which, if occurring simultaneously or in sequence, cause triggering. In some embodiments, the increasing/decreasing of the frequency and pulse length may be based on a fixed algorithm. In other embodiments, the device 200 may employ an adaptation technique such as fuzzy logic.

The methods 500, 700 and 900 provide several advantages over conventional activation methods. In addition to conserving power, the methods 500-900 may also provide for more accurate detection of triggering conditions. When objects are detected, the device 200 switches to a higher duty cycle, increasing a likelihood that an input signal will be successfully captured. By adapting to the presence of the input signal, the device 200 may eliminate a need to calculate a predetermined optimal duty cycle. This adaptation is also advantageous in that it does not require user intervention and is completely automated. Thus, the device 200 may be shared by a plurality of users and still be capable of successfully capturing the input signal.

Although the activation of the device 200 has been described with exclusive reference to RF triggering, it may also be possible to combine RF triggering with other triggering methods. Such methods include manual triggers, motion- or position-based sensors and optical sensors and historical triggers based upon past events. Combining triggering methods may help eliminate false positives which might result if any single method were used alone. In some embodiments, the device 200 may switch between triggering methods. For example, if the power level of the battery is at a critical level, the device 200 may switch from RF triggering to a less power-intensive triggering method such as manual triggering.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A device, comprising:
a function module; and
a triggering arrangement activating a function of the function module in a response to a triggering condition, wherein the triggering arrangement generates an interrogation signal, the response including at least one of (i) modifying a frequency of the interrogation signal, (ii) modifying a duration of the interrogation signal and (iii) modifying non-monotonic temporal distributions of interrogation events.

2. The device according to claim 1, wherein the modifying includes at least one of increasing the frequency and increasing the duration of the interrogation signal.

3. The device according to claim 1, wherein after responding to the triggering condition, the triggering arrangement further modifies the interrogation signal.

4. The device according to claim 3, wherein the further modification is in response to a failure to detect the triggering condition within a predetermined period of time that has elapsed since the detection.

5. The device according to claim 4, wherein the further modification includes decreasing the duration of the interrogation signal.

6. The device according to claim 5, wherein the duration of the interrogation signal is decreased to a minimum frequency.

7. The device according to claim 3, wherein the further modification is in response to a further detection of the triggering condition after a predetermined period of time that has elapsed since the detection.

8. The device according to claim 7, wherein the further modification includes increasing the duration of the interrogation signal.

9. The device according to claim 3, wherein the initial modification is a rapid increase in the frequency of the interrogation signal and the further modification is a gradual decrease in the frequency of the interrogation signal.

10. The device according to claim 1, wherein the triggering condition comprises bringing the triggering arrangement within a detection range of an object.

11. The device according to claim 10, wherein the object is one of an RFID tag and a wirelessly-enabled device.

12. The device according to claim 10, wherein the triggering condition is contingent upon a classification of the object.

13. A method, comprising:
detecting a triggering condition using an interrogation signal of a device; and
in response to the detection, modifying the interrogation signal, wherein the modification includes at least one of (i) modifying a frequency of the interrogation signal, (ii) modifying a duration of the interrogation signal and (iii) modifying non-monotonic temporal distributions of interrogation events.

14. The method according to claim 13, wherein the modifying step includes at least one of increasing the frequency and increasing the duration of the interrogation signal.

15. The method according to claim 13, further comprising:
after responding to the triggering condition, further modifying the interrogation signal.

16. The method according to claim 15, wherein the further modification is in response to a failure to detect the triggering condition within a predetermined period of time that has elapsed since the detection.

17. The method according to claim 16, wherein the further modification includes decreasing the duration of the interrogation signal.

18. The method according to claim 15, wherein the further modification is in response to a further detection of the triggering condition after a predetermined period of time has elapsed since the detection.

19. The method according to claim 18, wherein the further modification includes increasing the duration of the interrogation signal.

20. The method according to claim 15, wherein the initial modification is a rapid increase in the frequency of the interrogation signal and the further modification is a gradual decrease in the frequency of the interrogation signal.

21. The method according to claim 13, wherein the triggering condition comprises bringing the triggering arrangement a within a detection range of an object.

22. The method according to claim 21, wherein the triggering condition is contingent upon a classification of the object.

23. A device, comprising:
a function means; and
a triggering means activating a function of the function means in a response to a triggering condition, wherein the triggering means generates an interrogation signal, the response including at least one of (i) modifying a frequency of the interrogation signal, (ii) modifying a duration of the interrogation signal and (iii) modifying non-monotonic temporal distributions of interrogation events.
